(19) United States
(12) Patent Application Publication
(10) Pub. No.: US 2007/0191052 A1
(43) Pub. Date: Aug. 16, 2007

(54) Automatic power save delivery (APSD) compatible with 802.11n frame aggregation and block acknowledgement

(75) Inventors: Jarkko Kneckt, Espoo (FI); Jari Jokela, Ylojarvi (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/698,127

(22) Filed: Jan. 26, 2007

Related U.S. Application Data
(60) Provisional application No. 60/762,512, filed on Jan. 27, 2006.
(60) Provisional application No. 60/772,523, filed on Feb. 13, 2006.

(51) Int. Cl. H04B 7/00

(52) U.S. Cl. 455/522

(57) ABSTRACT

A mechanism to create Automatic Power Save Delivery (APSD) compatible with 802.11n frame aggregation and block acknowledgement (ack) mechanisms is provided. Various methods of using block acknowledgments are provided. Additionally, bit handling for defining an unscheduled APSD (U-APSD) service period and ending it is explained. A method of aggregating a plurality of data frames into an aggregated data frame, starting a service period based on the transmitting of the aggregated frame, receiving an acknowledgement for the transmitted frame, and upon receiving the acknowledgement frame containing an indicator indicating end of service period, entering low power mode of operation is enabled.

### CROSS REFERENCE TO RELATED APPLICATIONS

The present application is related to and claims the priority of U.S. Provisional Patent Applications No. 60/762,512, filed Jan. 27, 2006, and No. 60/772,523, filed Feb. 13, 2006, the entirety of both of which is incorporated herein by reference.

### FIELD OF THE INVENTION

The present invention relates, for example, to a mechanism to create Automatic Power Save Delivery (APSD) compatible with 802.11n frame aggregation and block acknowledgement (BA) mechanisms.

### BACKGROUND OF THE INVENTION

It is necessary to provide a mechanism for APSD that enables power save features to operate in 802.11n when aggregated frames and block acknowledgements are used.

The conventional art does not present how battery saving would be done in 802.11n where there are block acknowledgements and aggregated frames. Nor does the conventional art explain how the service interval is ended when block acknowledgement is used or a last receiver aggregate frame is received only partially correctly. Thus, there is a need to enable the triggering to work in an 802.11n scenario.

### SUMMARY OF THE INVENTION

The present invention may provide, for example, bit handling for defining an unscheduled APSD (U-APSD) service period and ending it.

The present invention may also provide, for example, a method of aggregating a plurality of data frames into an aggregated data frame, starting a service period based on the transmitting of the aggregated frame, receiving an acknowledgement for the transmitted frame, and upon receiving the acknowledgement frame or aggregated data and the acknowledgement frame containing an indicator indicating end of service period, entering low power mode of operation.

The present invention may also include accomplishing the power save operation by using determinations made from the received frames.

One embodiment of the present invention is a method. The method can include receiving a trigger frame from a terminal or other station (STA), using power save. The method can also include triggering a service period based on receiving the trigger frame. The method can further include sending a termination bit to the terminal, wherein the sending the termination bit to the terminal is configured to result in an end of the service period.

Another embodiment of the present invention is also a method. This method can include sending a trigger frame to an STA in full power, for instance to an access point, wherein the trigger frame is configured to trigger a service period based upon reception thereof. The method can further include receiving a termination bit from the STA in full power. The method can additionally include ending the service period based on the termination bit.

A further embodiment of the present invention is a wideband local area network (WLAN) station (STA) operating in a power save state, for instance, a terminal. The terminal includes a transmission unit configured to send a trigger frame to an access point or other node, operating in full power mode, wherein the trigger frame is configured to trigger a service period based upon reception thereof. The terminal also includes a reception unit configured to receive a termination bit from the access point. The terminal further includes a processor unit configured to end the service period based on the termination bit.

An additional embodiment of the present invention is also a terminal. This terminal can include transmission means for sending a trigger frame to an access point, wherein the trigger frame is configured to trigger a service period based upon reception thereof. The terminal can also include reception means for receiving a termination bit from the access point. The terminal can further include processor means for ending the service period based on the termination bit.

Another embodiment of the present invention is an access point. The access point can include reception means for receiving a trigger frame from a terminal. The access point can also include processor means for triggering a service period based on receiving the trigger frame. The access point can further include transmission means for sending a termination bit to the terminal, wherein the sending the termination bit to the terminal is configured to result in an end of the service period.

A further embodiment of the present invention is also an access point. The access point can include a reception unit configured to receive a trigger frame from a terminal. The reception point can also include a processor unit configured to trigger a service period based on receiving the trigger frame. The reception point can further include a transmission unit configured to send a termination bit to the terminal, wherein the sending the termination bit to the terminal is configured to result in an end of the service period.

Certain embodiments of the present invention, triggering the service period may use differing service period triggering and termination conditions depending on the block acknowledgment mechanisms used.

An additional embodiment of the present invention is a method. The method includes transmitting an ACK frame from a first station. The method also includes terminating a service period for delayed block acknowledgement using the ACK frame. The method further includes, when a block acknowledgement frame is received and indicates that all transmitted frames were received correctly, maintaining a current state instead of triggering a new service period. The method additionally includes, when the block acknowledgement frame is received and indicates that not all the transmitted frames were received correctly, triggering the new service period.

### BRIEF DESCRIPTION OF THE DRAWINGS

In the following, the present invention will be described in greater detail based on a preferred embodiment with reference to the accompanying drawings in which:

FIG. 1 illustrates aggregate frames transmitted by an AP.

FIG. 2 illustrates aggregate frames transmitted by a terminal.

FIG. 3 illustrates terminology and explanations used in power save cases.

FIG. 4 illustrates a simple case of 802.11n aware power save with a single receiver aggregate.

FIG. 5 illustrates an ongoing APSD service period between an AP and a terminal.

FIG. 6 illustrates a single receiver aggregate in which an AP transmits all frames to the same terminal.

FIG. 7 illustrates a single receiver aggregate transmitted by the terminal.

FIG. 8 illustrates a similar frame exchange to FIG. 7, except the AP uses a set EOSP bit in the BA frame.

FIG. 9 illustrates a single receiver aggregate in which the terminal obtains a TXOP for aggregated frames.

FIG. 10 illustrates an operation according to an embodiment of the present invention.

FIG. 11 illustrates a single receiver aggregate in which not all frames are received correctly, and a conventional solution is used for U-APSD handling.

FIG. 12 illustrates a delayed block ack according to mechanism in which all aggregates from AP had set EOSP, these are received correctly, and a delayed block ack starts a new service period.

FIG. 13 illustrates a delayed block ack, according to an embodiment of the invention in which all frames received correctly, and therefore a delayed block ack does not start new service period.

FIG. 14 illustrates a delayed block ack according to an embodiment of the invention, in which not all frames are received correctly.

FIG. 15 illustrates a situation similar to FIG. 14, except that the AP is able (in FIG. 15) to aggregate the wrongly received frames with an ACK frame.

FIG. 16 illustrates a delayed block ack, in which the terminal transmits aggregated data and access point (AP) responses with block ack.

FIG. 17 illustrates a multireceiver aggregate with immediate block ack according to a conventional solution, in which the exact multi-receiver aggregation mechanism is not specified.

FIG. 18 illustrates a multi-receiver aggregate with immediate block ack according to an embodiment of the invention, in which the exact multi-receiver aggregation mechanism is not specified.

FIG. 19 illustrates a multireceiver aggregate with immediate block ack according to an embodiment of the invention, in which the exact multi-receiver aggregation mechanism is not specified.

FIG. 20 illustrates a multireceiver aggregate with immediate block ack according to an embodiment of the invention, in which there is no buffered data for STA1 in power save (PS) and STA2 in PS, and the PSMP frame only defines an EOSP bit for terminal 2 and start and stop times from ack frame transmission interval. The specified time in PSMP frame may be used only by the specified user.

FIG. 21 illustrates a Block ACK Control Field.

FIG. 22 illustrates BAR Control field, that is used in BAR and multiple TID block acknowledgement frames.

FIG. 23 illustrates Multiple TID BAR frame and BAR frames.

FIG. 24 illustrates operation states in power save.

FIG. 25 illustrates various state changes in the terminal and access point.

FIG. 26 illustrates a general method according an embodiment of the present invention.

FIG. 27 illustrates a system according to an embodiment of the present invention.

### DESCRIPTION OF THE PREFERRED EMBODIMENTS

An embodiment of the present invention will now be described with regard to an example embodiment that includes an access point. Certain embodiments of the present invention may provide a mechanism to create Automatic Power Save Delivery (APSD) compatible with 802.11n frame aggregation and block ack mechanisms.

Certain embodiments of the present invention address a situation of aggregated frames transmitted from a terminal and the terminal receiving block acknowledgements to the transmitted aggregated frames.

Aggregated frames can serve as trigger frames to trigger service periods. Considering a terminal sending such a frame, the frame would trigger an unscheduled APSD (U-APSD) service period. Any correctly received frame from aggregated frames operates as a trigger frame to start the U-APSD service period for the terminal.

Another option in certain embodiments of the invention is to use trigger flags. Two flags can be used for delivery enabled Access Channel (AC) (deac) and non-delivery enabled AC (ndeac). The ndeac flag can mean that once a terminal has sent an UL frame with such a flag the access point (AP) can transmit only ndeacs to the terminal which sent the trigger frame, in the service period that was triggered. With deac set, the AP can transmit data also from deac. These flags can be in UL aggregation control, Block ACK Request (BAR) and Block ACK (BA) frames. Alternatively, only one trigger bit could be used to trigger traffic from all ACs.

As can be seen from the paragraph above, some of the embodiments of the invention are described in terms of uplink (UL) and downlink (DL) transmissions and refer to a full power STA as an access point and a power save STA as a terminal. The invention, however, is not limited to such cases, but can apply to ad hoc and mesh network cases as well. Indeed, the invention may be applied between any power save STA and any full power STA. Thus, no limitation should be inferred from reference to the terms access point or terminal in this specification.

When a delayed block ACK is received, it can be used to determine whether. service period was started or not. If the block ACK indicates lost frames, then the service period is started. If the delayed block ack is not received, then the STA in full power considers that the service period is terminated and that triggering from STA in power save is required to establish a new U-APSD service period.

Service period termination can occur when an End Of Service Period (EOSP) bit is received in a block ACK frame, or block ack aggregated with QoS NULL and Acknowledge are received. Block ACK thus can be terminating the service period only when it is acknowledged, or if it is a part of an aggregated frame, which is acknowledged.

If a delayed block ack mechanism is used, the STA in full power can consider that the service prior with the STA in power save is terminated, if an acknowledgement frame is received for a frame or aggregated frames from the STA in full power containing a set EOSP bit.

The transmission of the delayed block ack from the STA in power save can trigger a service period only if it indicates that frames from the last transmitted aggregated frame have not been correctly received or if the block ack frame is aggregated with another frame that triggers the service period.

Having aggregated frames with multiple recipients the EOSP and More Data bits can be set independently in the DL PPDUs. The EOSP and more data bits can be in every aggregated MPDU or just in the aggregation control frames, or the last or the first aggregated frame.

Certain embodiments of the present invention may accrue various advantages. For example, by defining how the service period is started and how it is ended for a terminal transmitting and receiving aggregated frames, the terminal may be able to save battery power.

The service period can be started based on aggregation information frame received by AP from the terminal, and ended by determining the end from received aggregation information frames and a flag therein indicating EOSP.

The above general principles will now be described with reference to the attached figures. Note, in all figures, the shown Physical Protocol Data Unit (PPDU) is considered to have set EOSP bit, so it is the last transmitted frame before terminal may go to sleep.

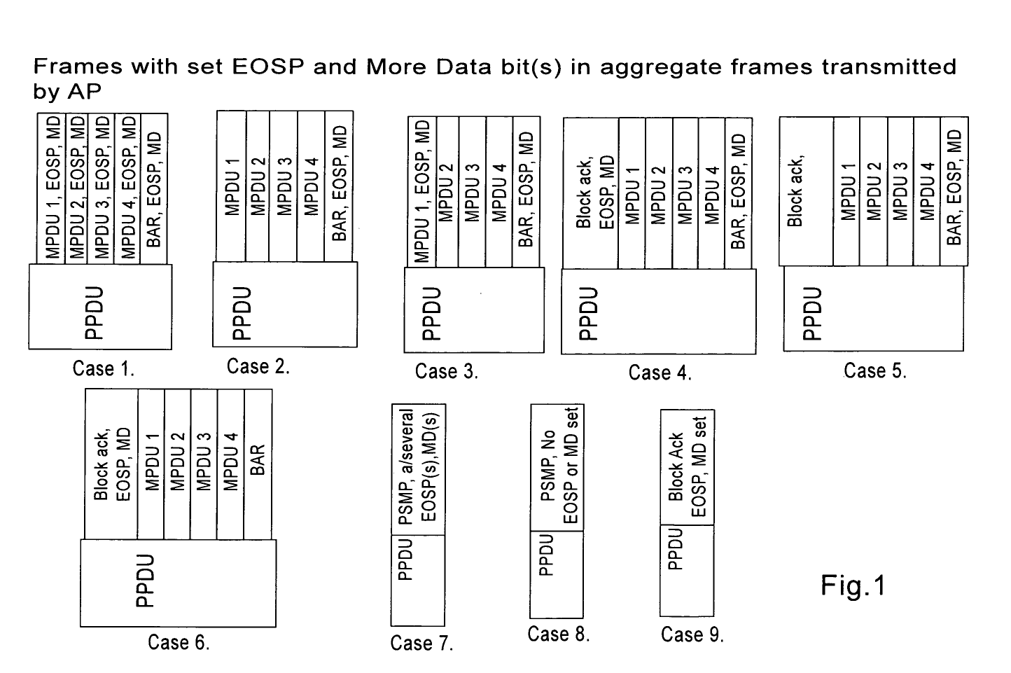

FIG. 1 illustrates frame aggregates transmitted by the AP. The figure shows different embodiments for valid EOSP and More Data (MD) bits information. The frames that are identified with EOSP and MD labels in FIG. 1 represent the EOSP and More Data bits value after the aggregated frame is transmitted. The frames that do not have EOSP or MD labels in FIG. 1 can have EOSP and More Data bits set to zero.

The EOSP and MD fields in these frames can be reserved, and can be configured not to contain valid information in the EOSP and MD filed. FIG. 1 shows a BAR frame at the end of each aggregate. A BAR frame may not be present in each aggregated frame. If the BAR frame is not present in the aggregated frame, valid EOSP and MD information can be present in the aggregated frames as shown in the illustrated cases.

In case 1 all frames in aggregate contain valid EOSP and More Data bit values. In case 2 only the last frame, Block ACK Request (BAR), contains valid EOSP and More Data bit values. In case 3 the first frame and the BAR contain valid EOSP and More Data bit values. In case 4 the Block ACK (BA) frame that is located as the first frame in aggregate contains valid EOSP and More Data bit values.

In case 5 the first BA does not have valid values, while the last BAR contains valid EOSP and More Data bit values. In case 6 only the first BA frame contains valid EOSP and More Data bit values.

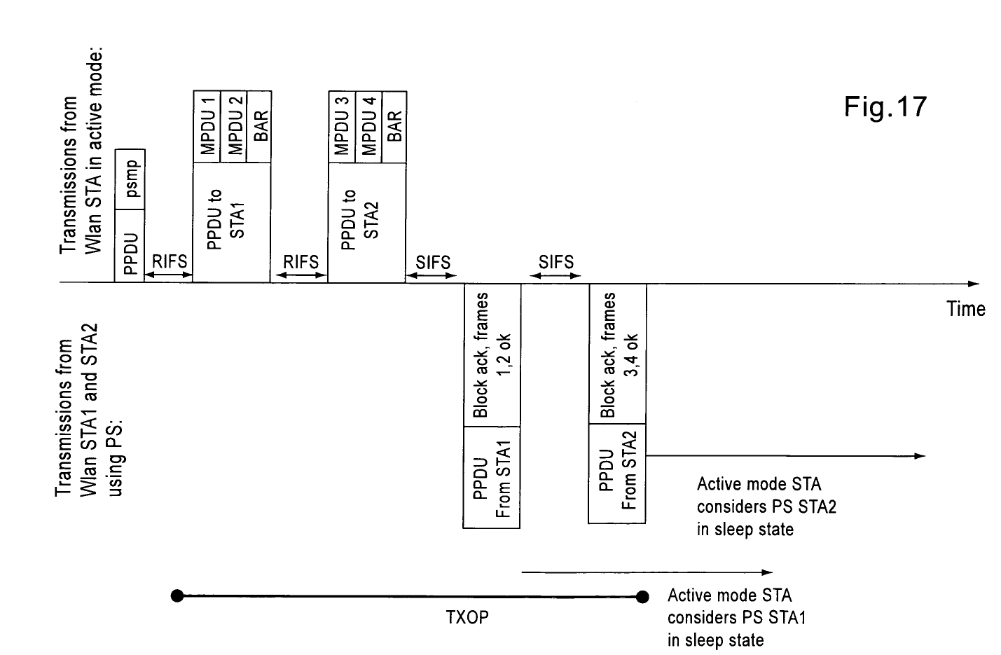

In case 7 the Power Save Multi Poll (PSMP) frame is shown. This frame is used to define multi receiver aggregate. As case 7 shows, the PSMP frame can be used to carry valid EOSP and More Data bit values for all receivers for a multireceiver aggregate. When PSMP is used to carry PSMP and MD bit values in a unicast transmission, the aggregated frames may not contain any valid MD or EOSP bits or, alternatively, any of the aggregated frame formats, as shown in cases 1-6 transmitted by the AP to a single terminal during multireceiver Transmission Opportunity (TXOP) may be used. An example illustration of multireceiver aggregate is shown in FIG. 17. PSMP may also be used to describe frame exchange with only a single receiver.

Case 8 shows an embodiment in which PSMP frame is not used to carry valid EOSP or More Data bit values. Case 9 shows an embodiment in which a Block ACK frame is used to carry EOSP and More Data bit values.

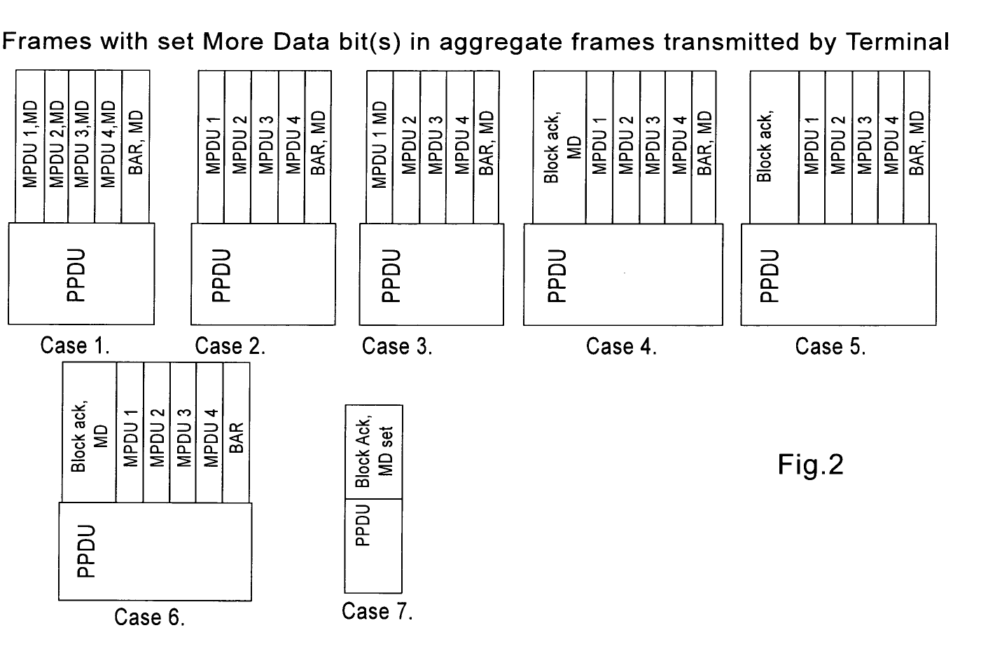

FIG. 2 illustrates frame aggregates transmitted by terminal. The figure shows different embodiments for valid More Data (MD) bit(s) information. The frames that are identified with MD labels in FIG. 1 represent the More Data bit value after the aggregated frame is transmitted. The frames that do not have MD labels in FIG. 1 can have More Data bit set to zero.

In case 1 all frames in aggregate contain valid More Data bit value. In case 2 only the last frame, Block ACK Request (BAR) contain valid More Data bit value. In case 3 the first frame and the BAR contain valid More Data bit value.

In case 4 the Block ACK (BA) frame that is located as the first frame in aggregate contain valid More Data bit value. In case 5 the first BA does not have valid MD value, while the last BAR contains a valid More Data bit value.

In case 6 only the first BA frame contains a valid More Data bit value. Case 7 shows embodiment in which a Block ACK frame is used to carry a More Data bit value.

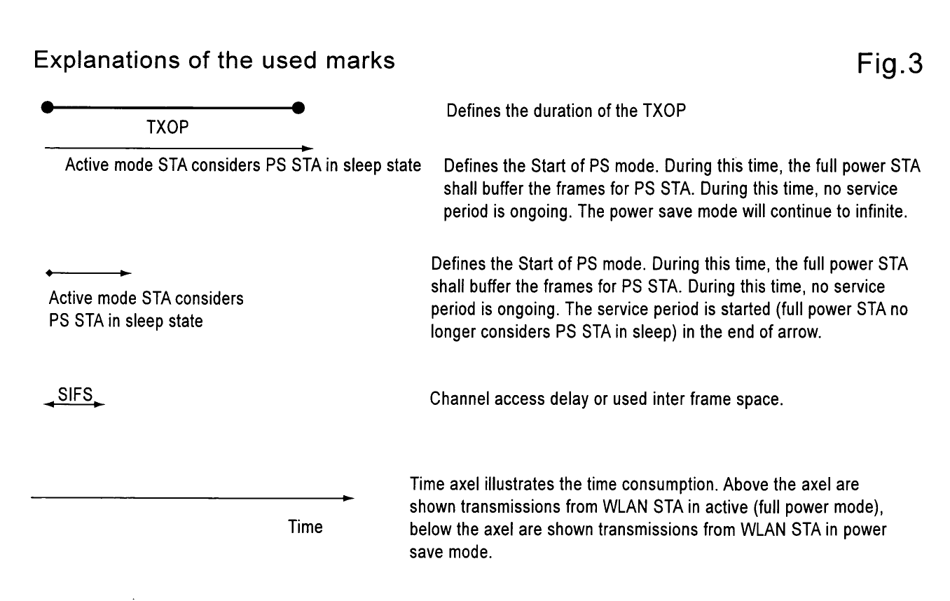

FIG. 3 illustrates terminology and explanations used in power save cases. For example, as shown, a line with two end points defines the duration of a transmission opportunity. Continuing from top to bottom, the first long arrow with one head, but no fixed end point indicates the start of power save mode that can continue indefinitely, and, theoretically, infinitely. During power save (PS) mode the full power STA can buffer frames for the power save (PS) STA. During such a period there is no ongoing service.

The third arrow from the top, with one head and one endpoint also indicates a PS mode. However, in the case of such an arrow, the sleep is over at the head of the arrow. Thus, for time beyond the arrow head, the full power STA may no longer consider the PS STA to be in sleep.

The fourth arrow with two heads is used to indicate channel access delay or used inter frame space. The position of the arrow heads indicate the duration of the period. The final arrow is the time axis. The transmission shown above the time axis can be from a WLAN STA in active (full power) mode, while the transmissions below the time axis may be transmission from a WLAN STA in power save mode.

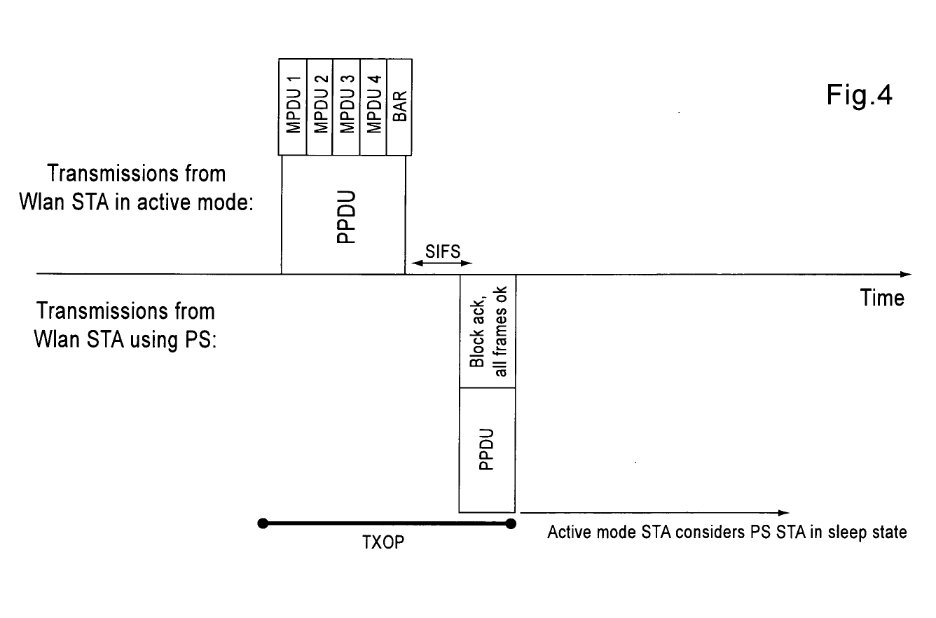

FIG. 4 illustrates a single receiver aggregate. The terminal has an ongoing APSD service period with the AP. All transmitted frames in the figure are received correctly. The AP sets an EOSP bit to a PPDU, which is transmitted to terminal. Immediate block ack can be used for data exchange and after the transmitted Block ACK (BA) frame the terminal may return to power save state. The Block ACK Request (BAR) may be used in the end of the aggregate frame, transmitted by AP, to request Block ACK (BA) frame.

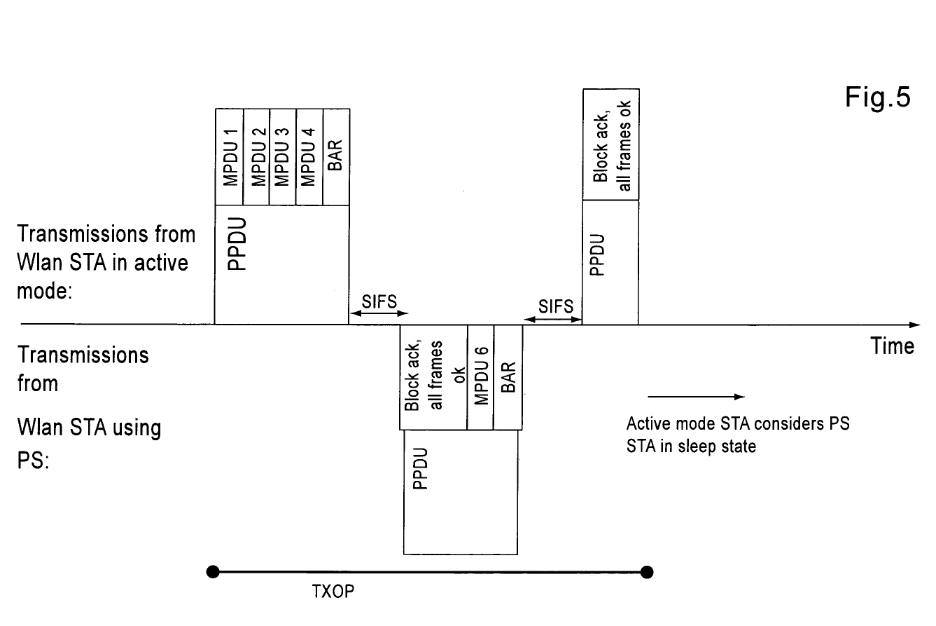

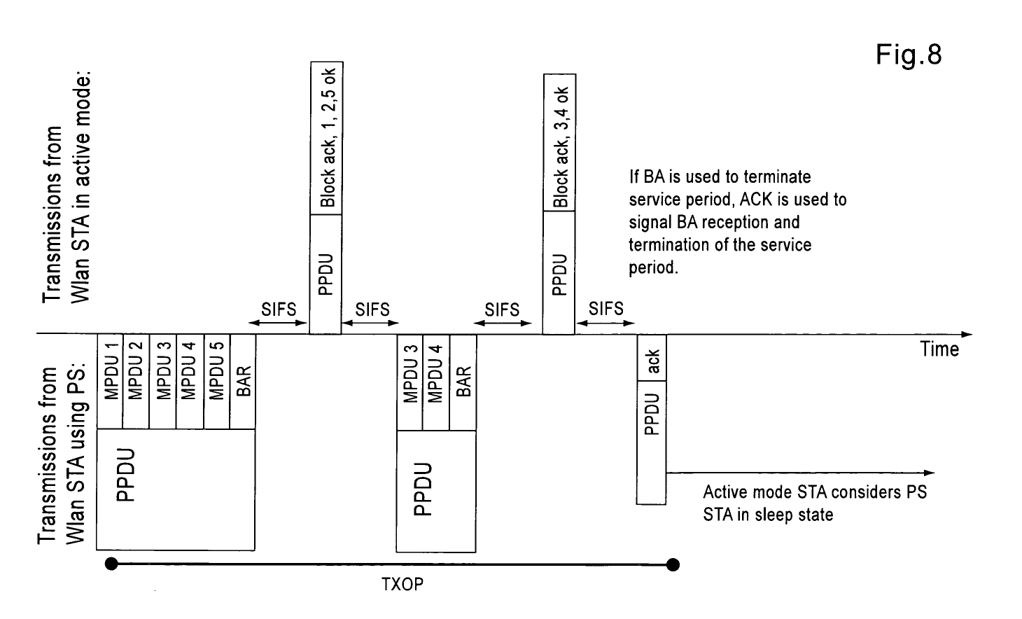

FIG. 5 illustrates a situation in which a terminal and an AP are engaging in an ongoing APSD service period. Both the initiator and the target node are transmitting data in the same TXOP. The AP transmits a single receiver aggregate frame with a set EOSP bit. The terminal responds with an aggregated immediate Block ack and data frame. The transmitted frame from the terminal does not set the trigger bit and, thus, does not start a new service period. The AP transmits a BA for the terminal's frame. After the frame exchange the AP considers the terminal to be in a power save state. The terminal uses one of the mechanisms discussed below to avoid triggering a new service period with the AP. All transmitted frames are received correctly. If the terminal would have set the transmitted frame to trigger, it would have triggered a service period. In order to terminate a service period, the BA may contain a set EOSP bit and the BA should be acknowledged as shown in FIG. 8.

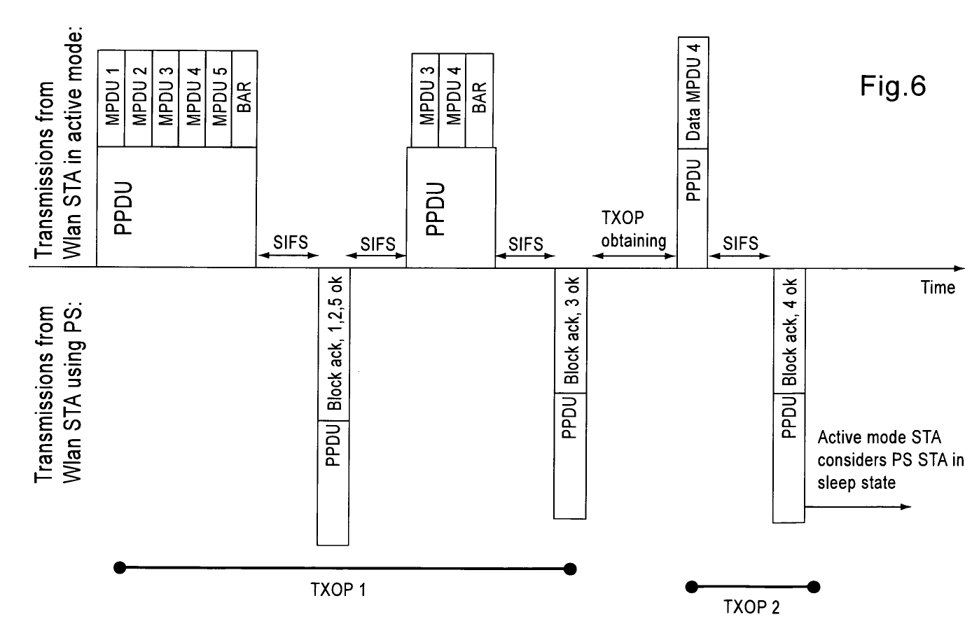

FIG. 6 illustrates a single receiver aggregate in which the AP transmits all frames to the same terminal. All transmitted frames contain a set EOSP bit. In transmissions, not all frames are received correctly, and retransmission occurs according to an embodiment of the present invention. The terminal stays in full power state until it receives the transmitted aggregated frame with a set EOSP bit correctly.

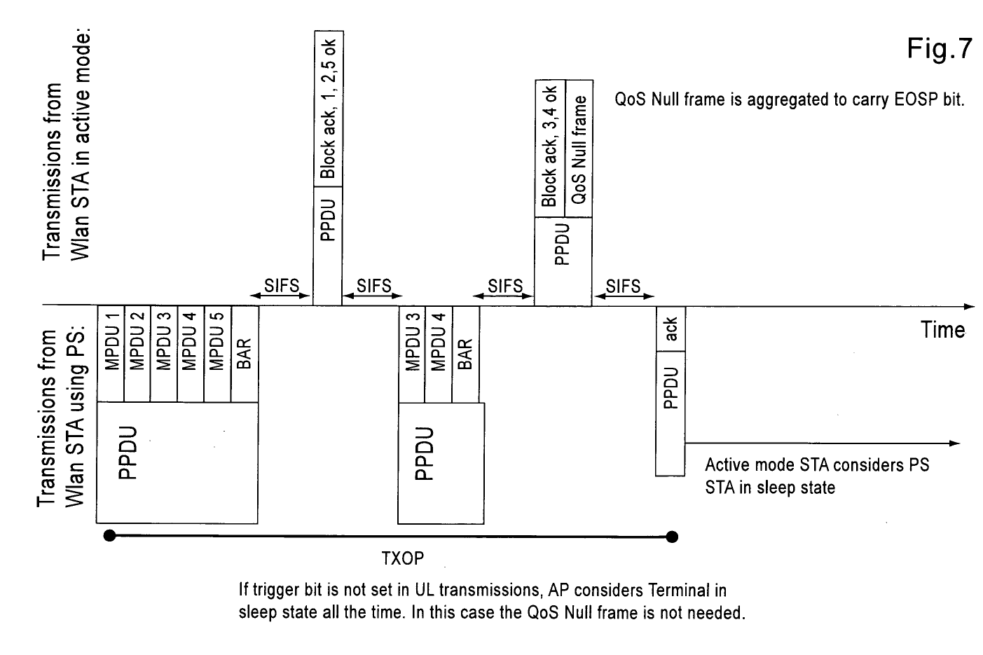

FIG. 7 illustrates a single receiver aggregate transmitted by the terminal. In the aggregated frame, if all frames are not received correctly, retransmission can occur according to an embodiment of the present invention, and an immediate block ack can be used. If the AP does not desire to continue the APSD service period, it may terminate the service period with the aggregated frame, for instance, QoS-NULL frame and BA frame. The QoS-Null frame can be acknowledged by the terminal.

FIG. 8 illustrates a similar frame exchange as shown in FIG. 7, except that the AP uses a set EOSP bit in the BA frame. If the terminal receives a BA with the EOSP bit set, it can acknowledge the frame. After the AP has received the acknowledgement it considers the terminal to be in power save state. Therefore, the second frame transmitted from the AP has the EOSP bit set.

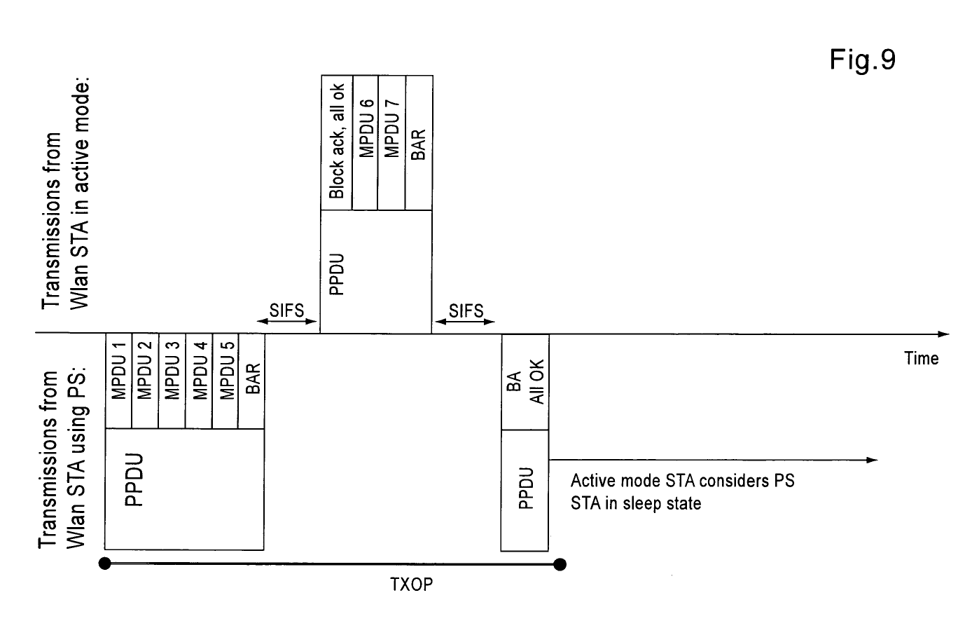

FIG. 9 illustrates a single receiver aggregate in which the terminal obtains a TXOP for aggregated frames. The AP responds with an aggregated frame that contains a Block ACK, data frames, and a Block ack request for the terminal. The transmitted aggregate frame contains EOSP for the terminal. The terminal acknowledges the frames transmitted by the AP. After receiving the frames from terminal, the AP considers the terminal in power save state.

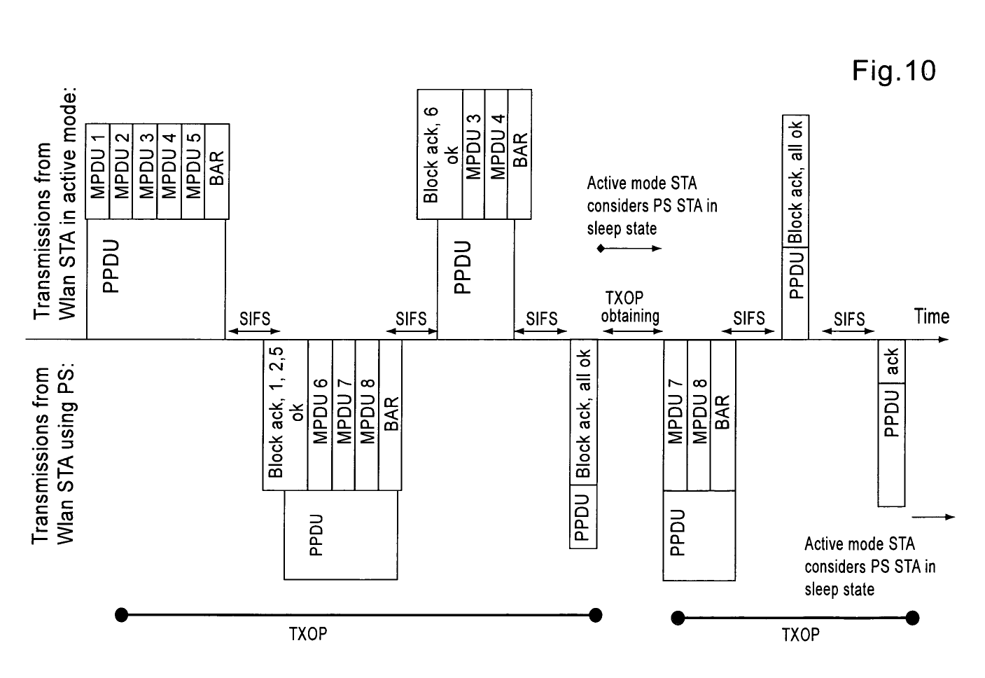

FIG. 10 illustrates an operation according to an embodiment of the present invention. In the figure the terminal and the AP are having APSD service period ongoing. The AP transmits aggregate PPDU with set EOSP bit to terminal. The terminal responds with the reverse direction aggregation frame, containing block ack and MAC frames. In the block ack frame the terminal responds that it has not received all aggregated frames correctly. The AP responds to the reverse direction aggregation with set EOSP bit, a block ack frame, showing that not all frames have been received correctly and retransmits the failed frames from previous aggregate.

The terminal receives the finally transmitted frame correctly and transmits a successful block ack to AP. Because the terminal successfully acknowledged the aggregated frame that contained the set EOSP bit, the AP will consider terminal to be in power save. The status of the terminal's frames delivery does not affect the termination of the service period. The terminal obtains new TXOP for the frames needing retransmission and transmits them to the AP. The AP can consider that the transmitted frames start a new service period.

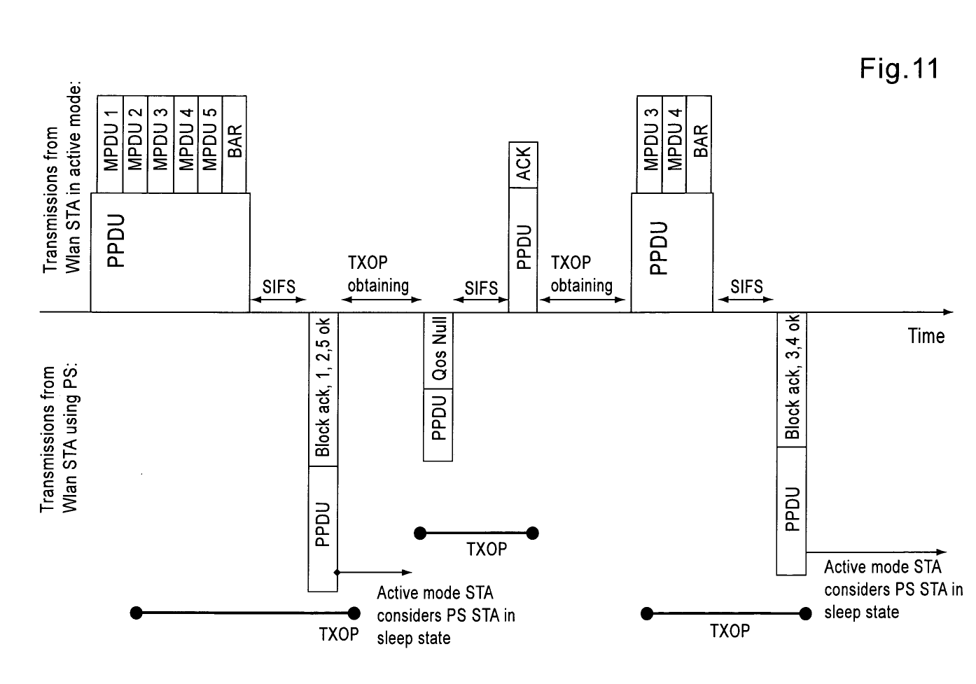

FIG. 11 illustrates a single receiver aggregate in which not all frames are received correctly, and a conventional solution is used for U-APSD handling. In this figure the transmitters are using delayed block ack, in which the responder is not able to respond with block ack, but just to send ACK and send block ack in the next TXOP. Also, in this figure, the AP has set the EOSP bit in data transmissions and the AP considers the terminal in power save after it has received the frames and acknowledged them to the AP.

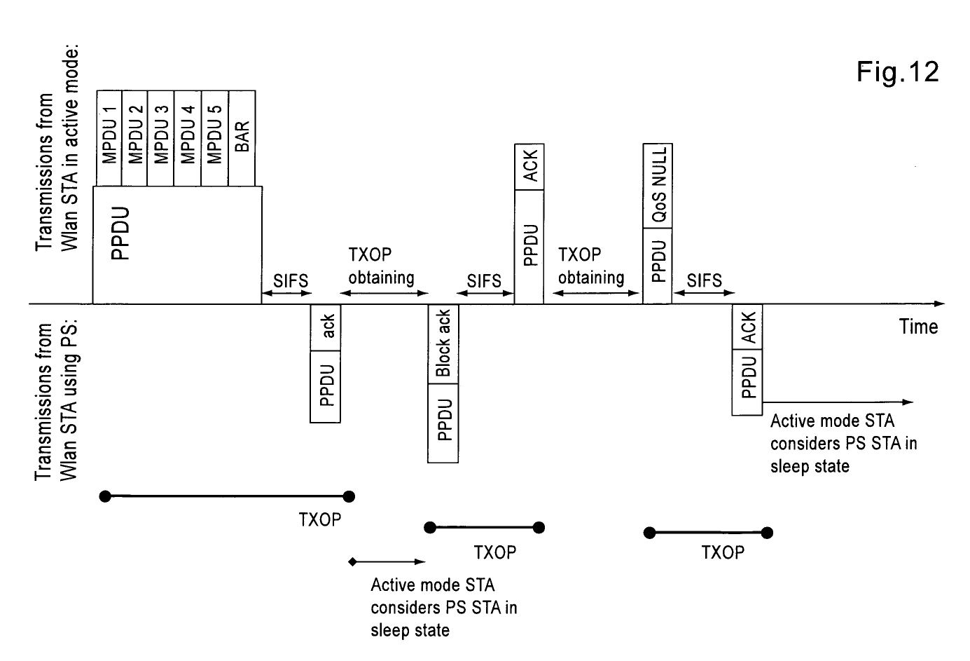

FIG. 12 illustrates a delayed block ack according to a mechanism in which all aggregates from the AP had a set EOSP, these aggregates are received correctly, and a delayed block ack starts a new service period. The handling of delayed block ack in FIG. 12, can be viewed as conventional handling for delayed block ack. This mechanism can help to expand 802.11e power save mechanisms.

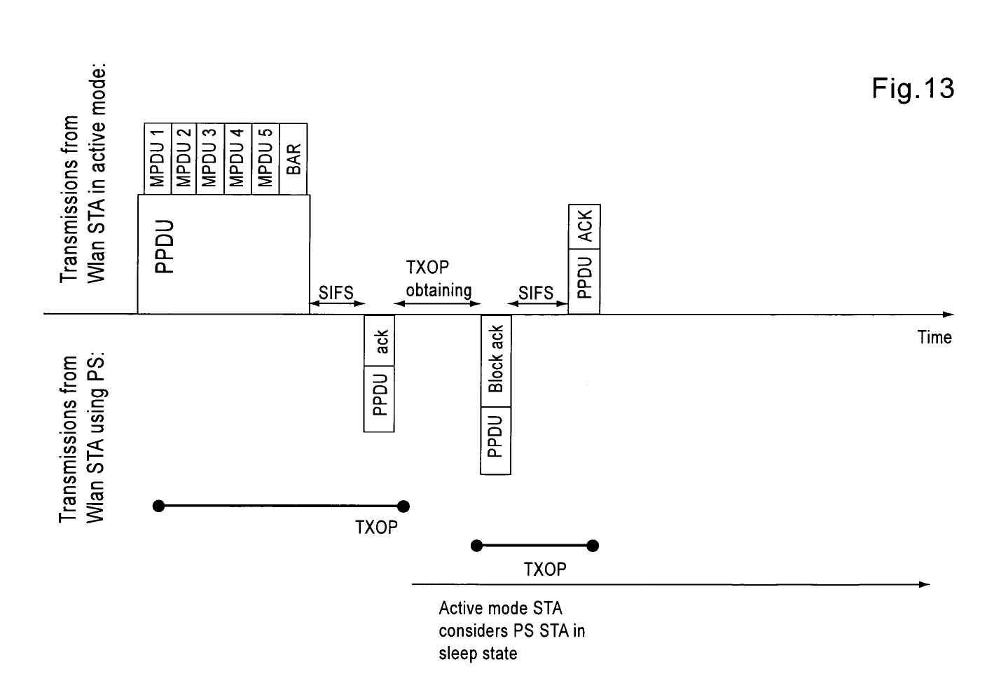

FIG. 13 illustrates a delayed block ack according to an embodiment of the invention in which all frames are received correctly. A delayed block ack does not start new service period, because all frames were received correctly. The AP transmits aggregated frames that have set EOSP bit. The terminal acknowledges these frames and the AP considers the terminal in power save state.

The terminal transmits Block ack, which defines that all frames are received correctly and the AP does not start a new service period for the terminal. The last acknowledgement transmitted by AP is a normal acknowledgement frame as defined in 802.11, which can provide a basis for future enhancements.

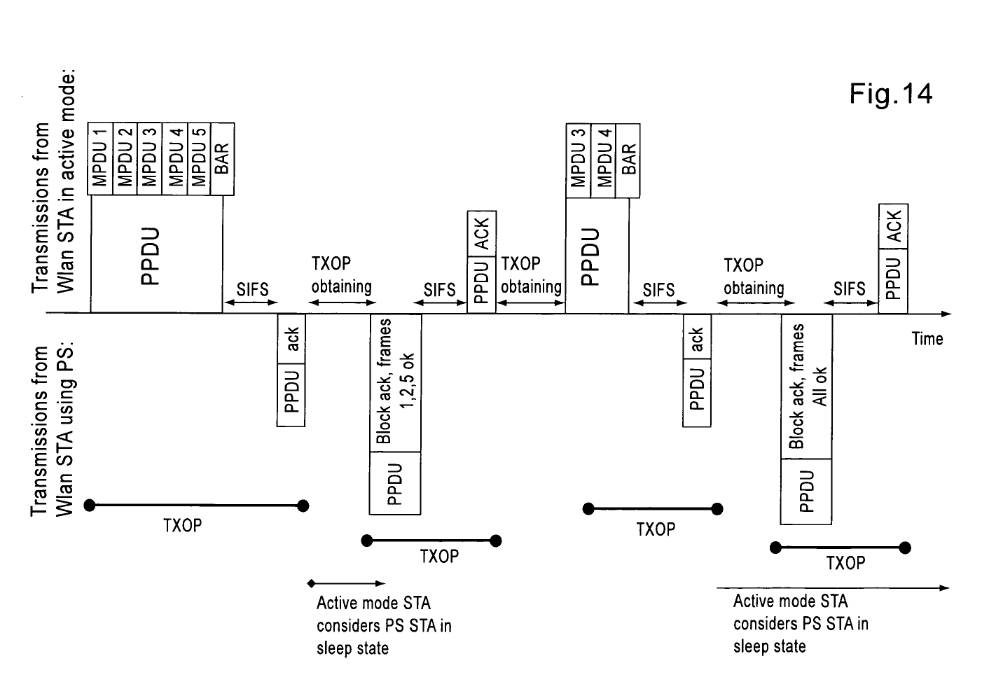

FIG. 14 illustrates a delayed block ack according to an embodiment of the invention, in which not all frames are received correctly. The aggregated frames transmitted from the AP may contain a set EOSP bit. The terminal acknowledges these frames. After receiving the acknowledgement, the AP considers the terminal to be in a power save state. The terminal obtains a new TXOP for block ack transmission in which it indicates that it has not received all frames correctly. This frame triggers a new service period. The AP retransmits the frames and the service period termination can operate as described in FIG. 12.

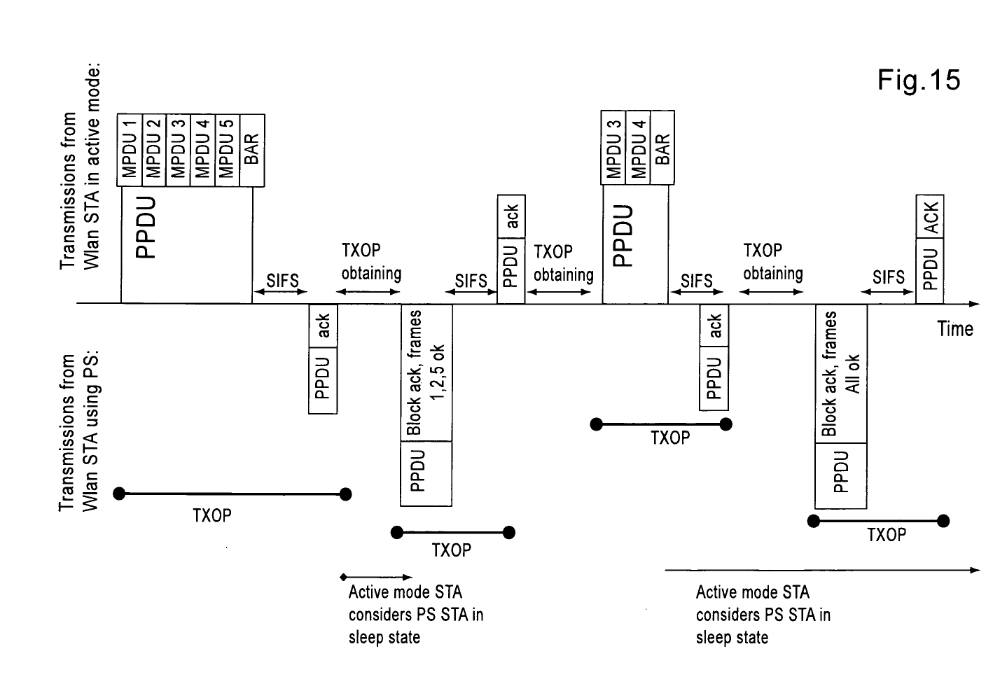

FIG. 15 illustrates a delayed block ack according to an embodiment of the invention, in which all frames are not received correctly. The operation illustrated in FIG. 14 is similar to the operation illustrated in FIG. 13, except that in FIG. 14 the AP is able to retransmit the incorrectly received frames in an aggregate frame with a block ack frame. The AP then considers the terminal in power save state after it has acknowledged the retransmitted data frames aggregate.

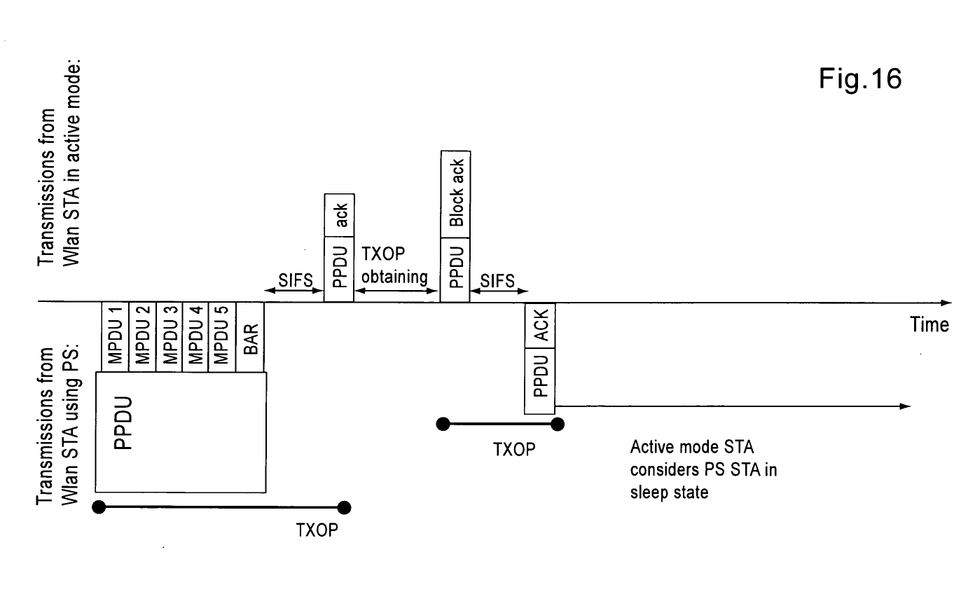

FIG. 16 illustrates a delayed block ack, in which the terminal is triggering a service period with aggregated frames. The AP can acknowledge the transmitted frames and obtain a new TXOP for block ack. The transmitted block ack can contain a set EOSP bit, which can be acknowledged by the terminal. After the transmitted acknowledgement by the terminal, the AP can consider the terminal to be in power save.

FIG. 17 illustrates a multireceiver aggregate with immediate block ack according to a conventional solution, in which the exact multi-receiver aggregation mechanism is not specified. In multireceiver aggregate transmission an interframe space called Reduced InterFrame Space (RIFS) can be used between frames targeted to different recipients. Such an interframe space is shorter than other interframe spaces use in wideband local area networks (WLANs), such as DIFS (distributed interframe space), SIFS (short interframe space) and other interframe spaces. AP transmits two aggregated frames to terminals 1 & 2 both with a set EOSP bit. Both frames are received correctly and after the terminals have transmitted respective block ack frames, the AP considers the terminals in power save state as illustrated. If the frames transmitted by the AP to a terminal had not contained a set EOSP bit, the terminal would have stayed in full power operation mode.

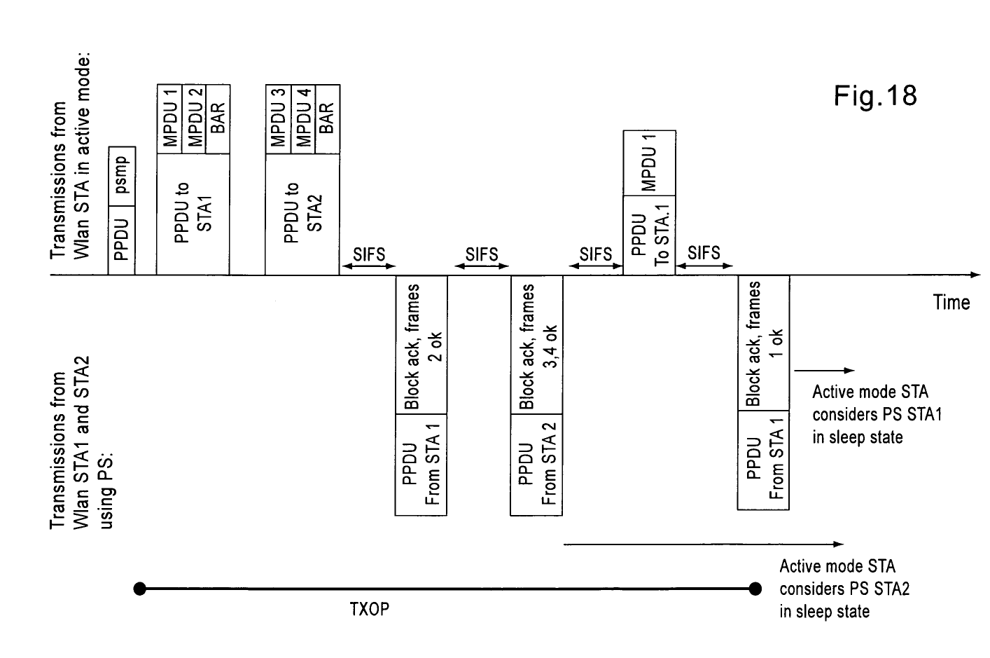

FIG. 18 illustrates a multi-receiver aggregate with immediate block ack according to an embodiment of the invention in which the exact multi-receiver aggregation mechanism is not specified. The figure demonstrates how to use a Power Save Multi Poll (PSMP) frame for multi-receiver aggregation. The PSMP frame contains information of the download (DL) and upload (UL) transmission times for each receiver in TXOP. PSMP can help to conserve power by scheduling communications, as opposed to sending/receiving at random intervals.

The PSMP frame can be embodied as a MAC control frame that provides a time schedule to be used by the system's transmitters and receivers. Normally, the scheduled time begins immediately subsequently to the transmission of the frame. The AP transmits frames with set EOSP bits. Terminal 1 does not receive all frames correctly, and the AP does not consider terminal 1 to be in power save state after it receives block ack from the terminal 1. Terminal 2 receives all frames correctly and the AP considers terminal 2 in power save after receiving ack from terminal 2.

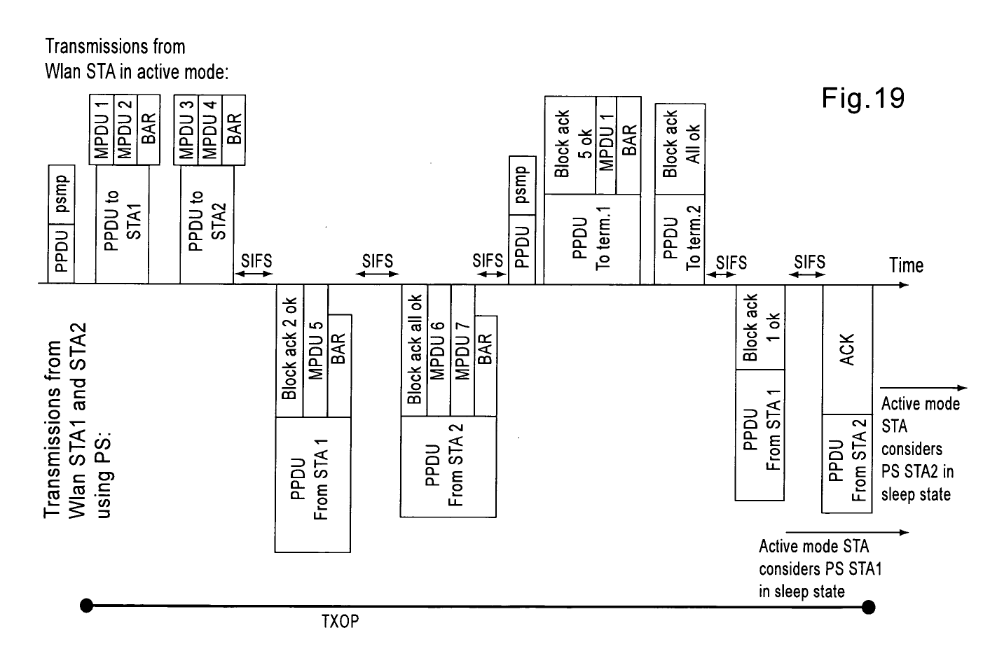

FIG. 19 illustrates a multireceiver aggregate with immediate block ack according to an embodiment of the invention in which the exact multi-receiver aggregation mechanism is not specified. The power save multi poll (PSMP) frame or frames 1-4 contain a set EOSP bit for both terminals. The terminals transmit aggregated block ack and data frames as a response to the AP's aggregate. The AP transmits a new aggregate for the terminals in which the AP acknowledges the frames transmitted by terminal 1 and retransmits the failed frame with EOSP bit set in the response frame and acknowledges the frames transmitted by terminal 2.

In the PSMP frame the AP has allocated time for terminal 1 block ack and terminal 2 acknowledgement. The allocated time for terminals transmission may be longer than as shown in the figure. In such case, the terminals may transmit data to the AP. After the PSMP frame is transmitted, the AP considers the terminals to be in power save state. PSMP frame contains transmission start and end times for each terminal after the PSMP frame.

The PSMP frame can be used to transmit a large aggregate frame from AP to several terminals. The PSMP frame also can specify transmission start and stop times for a specific terminal. Depending on the duration of the UL transmission time, the responses from the terminals may contain both data and block acknowledgement frames, only a block acknowledgement frame or an ack frame.

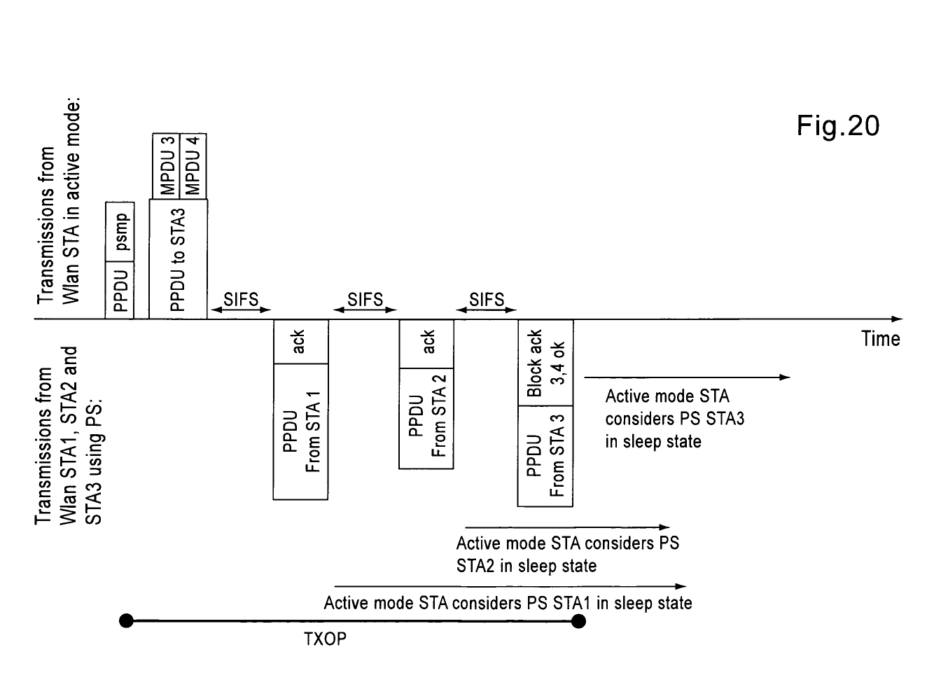

FIG. 20 illustrates a multireceiver aggregate with immediate block ack according to an embodiment of the invention, in which there is no buffered data for terminal 1, and PSMP frame only defines EOSP bit for the terminal 2 and start and stop times from ack frame transmission. The transmission to other terminals is illustrated as a frame transmission to only terminal 2, as an example, but the figures from multi aggregate operation could have several terminals in aggregates frame transmission. The terminal 2 can operate as described in FIGS. 19 and 20.

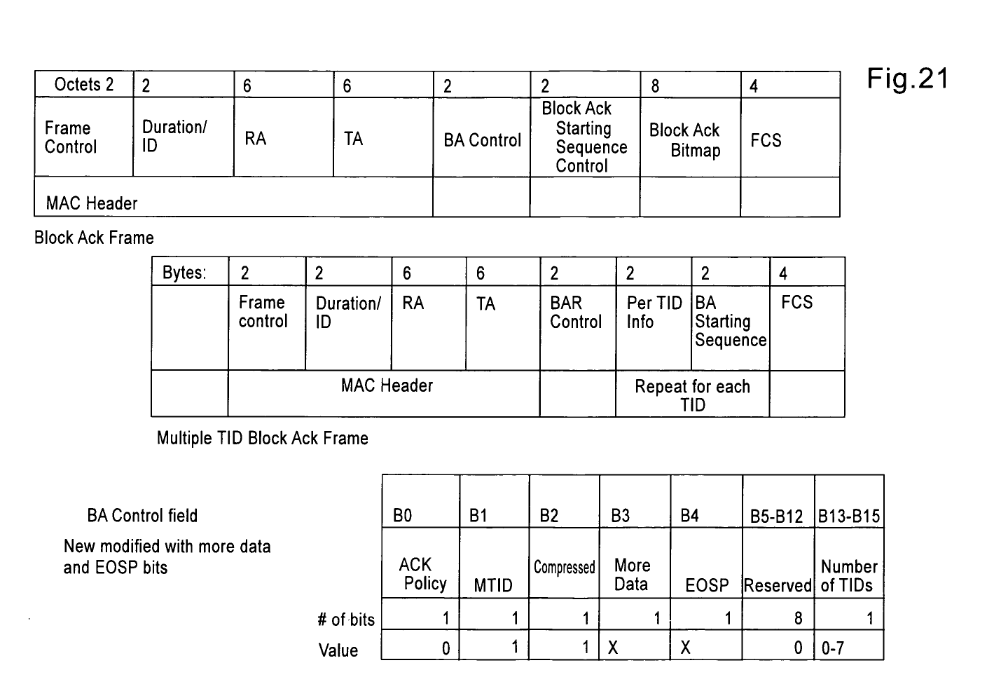

FIG. 21 illustrates a Block ACK Control Field. The Block ACK Control field is used in block acknowledgement (BA) and Multiple Traffic Identification (TID) Block Acknowledgement frame formats. Certain embodiments of the pressent invention can provide Block ACK, Control Field, More Data, and EOSP bits. These bits can be used as described in 802.11e amendment and if the BA is part of the aggregated frame these bits can contain valid information as described in FIGS. 1 and 2 above. The Multiple TID Block ACK frame can be used when only a PSMP frame is used, as shown, for example, in FIGS. 17-20. The Block ACK frame may be used for cases shown in FIGS. 4-16.

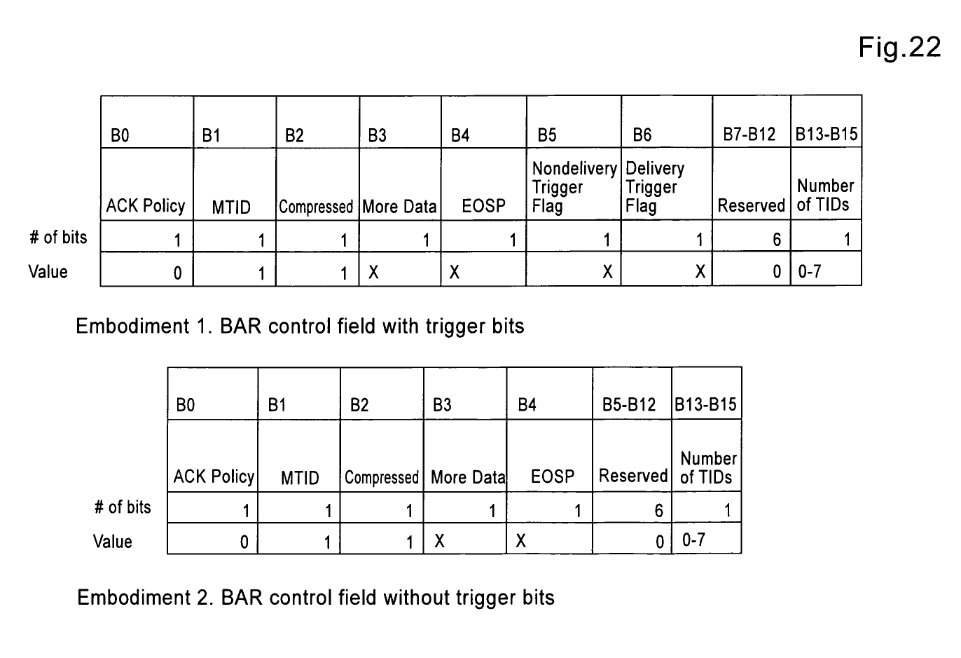

FIG. 22 illustrates a BAR Control field that is used in BAR and multiple TID block acknowledgement frames. The invention can employ two embodiments for BAR Control Field. In the first embodiment the BAR Control Field frame contains two trigger frames, and in the second embodiment the trigger frames are present in the BAR Control Field.

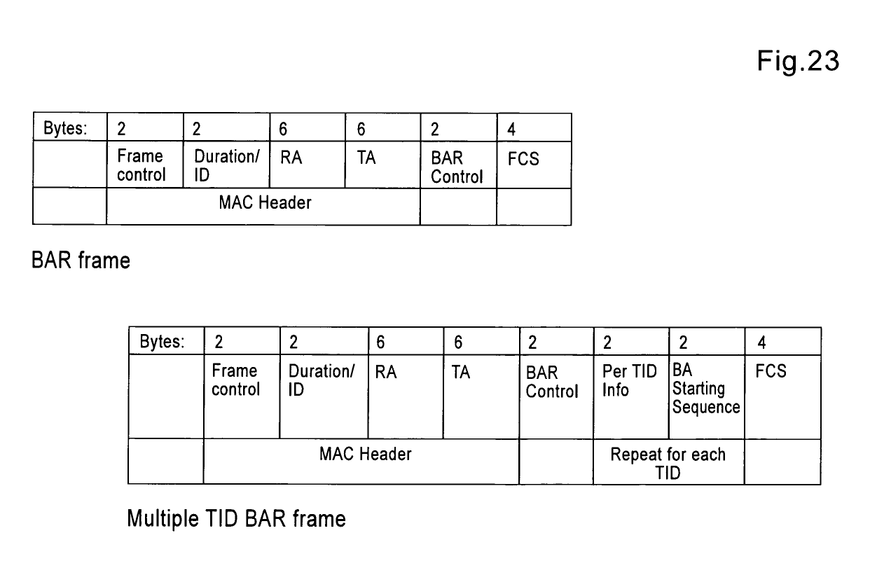

FIG. 23 illustrates Multiple TID BAR frame and BAR frames. Both of these frames use a BAR Control Field as discussed above, in regard to FIG. 20. The trigger flags can be set by the terminal and the AP can consider these bits as reserved. Two trigger flags can be used for delivery enabled AC (deac) and non-delivery enabled AC (ndeac). The ndeac flag can indicated that once terminals have sent a UL frame with such a flag the access point (AP) can transmit only ndeacs to the terminal that sent the trigger frame in the service period that was triggered. With deac set, the AP can transmit data also from deac.

Certain embodiments of the present invention provide Block ACK Control Field More Data and EOSP bits. These bits can be used as described in 802.11e amendment and, if BA is part of the aggregated frame, these bits can contain valid information as described in regard to FIGS. 1 and 2 above.

The trigger flags may be used in other frames, like Quality of Service (QoS) Null frames to trigger service period. Also just a plain Block ACK Request frame may be transmitted to trigger a U-APSD service period.

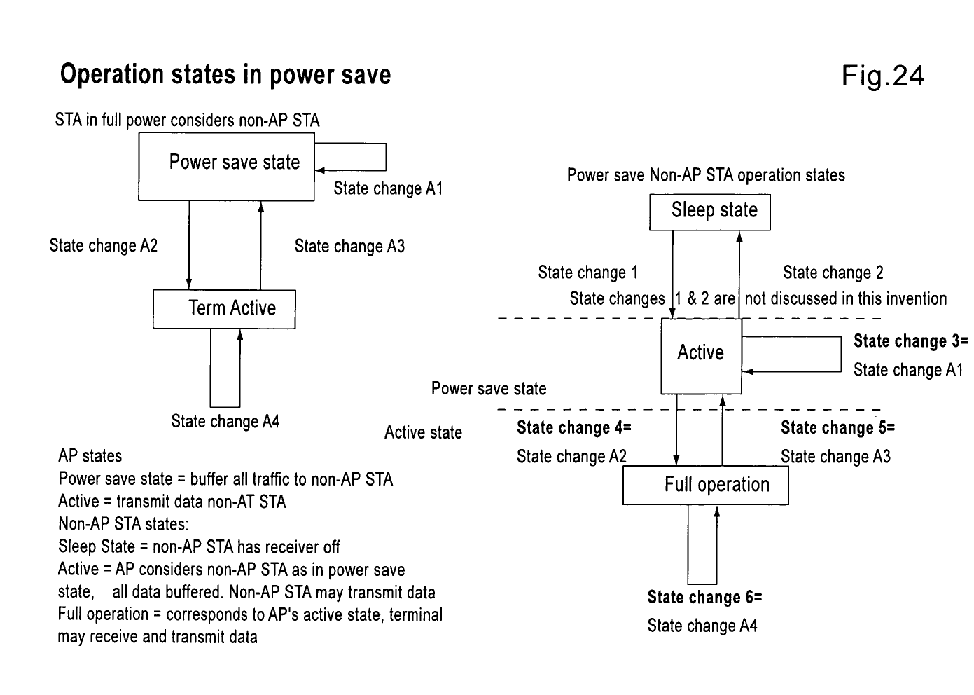

FIG. 24 illustrates various operational states in power save. As illustrated in FIG. 24, a non-AP station (STA) can initially be in a sleep state. It can than exhibit a state change to active state. One form of active state is a power save state. While in power save state, the STA can change state to sleep state, can refresh its power save state, or can change state to full operation. Similarly in full operation, the STA can refresh its full operation state or revert to power save state. It is considered that, in sleep state, the receiver of the STA is off. In active power save state, the access point (AP) considers the STA in power save state, but the STA may transmit data.

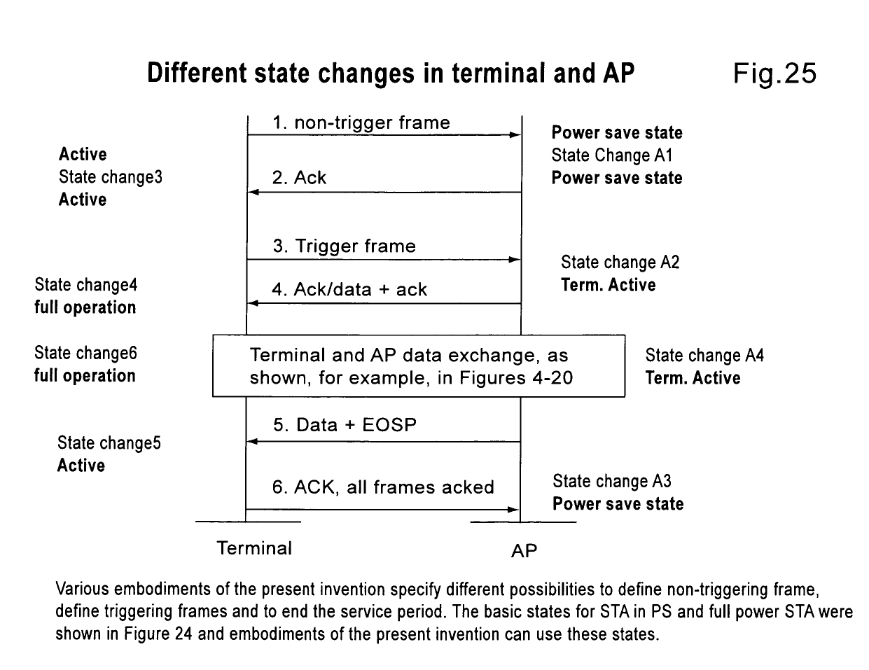

FIG. 25 illustrates various state changes in the terminal or STA and the AP. As illustrated, a non-trigger frame to the AP and an ACK from the AP can trigger the AP to consider the terminal in power save state, while the terminal considers itself refreshed in its power save state. A trigger frame to the AP and an ACK or data plus ACK from the AP can trigger the AP to consider the terminal active, and can cause the terminal to consider itself in full operation. While the terminal and AP share this understanding, they may exchange data (as illustrated, for example, in FIGS. 4-20) while refreshing their states.

When the data plus EOSP is sent from the AP, the terminal may consider itself in power save state, and send an ACK acknowledging all frames. The AP may receive the ACK and consider the terminal in a power save state.

Although the invention has been described in terms of the present embodiment of 802.11, it will be recognized by one of ordinary skill in the art, that the invention will be applicable to future versions of 802.11 and to other communication standards that may arise in the future.

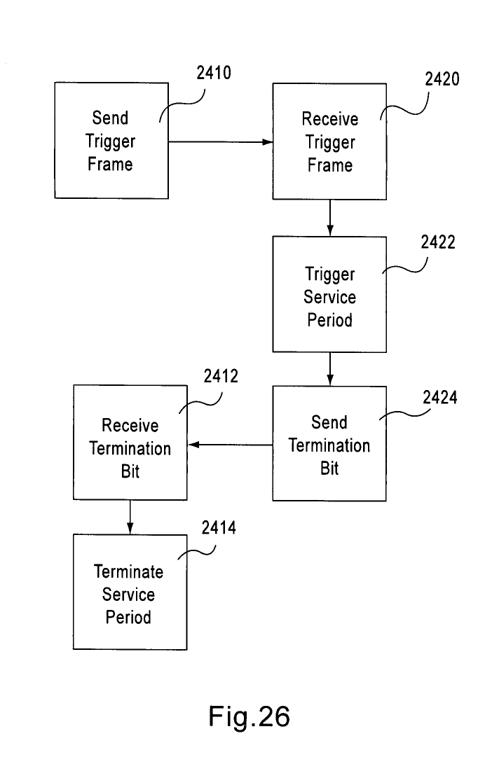

FIG. 26 illustrates a general method according an embodiment of the present invention. As shown in FIG. 26, the method may begin with a terminal, such as a user equipment, mobile phone, personal digital assistant or other portable, communication-enabled electronic device, sending 2410 a trigger frame. The trigger frame may be received 2420 by an access point. The access point may, in response to the trigger frame, if certain conditions are met, trigger 2422 a service period.

At some point, which may be starting at the very next communication by the access point, or may be deferred until a later time, the access point may send 2424 a termination bit to the terminal.

The terminal may receive 2412 the termination bit. If certain prerequisites are met, as described in more detail above, the terminal may terminate 2414 the service period.

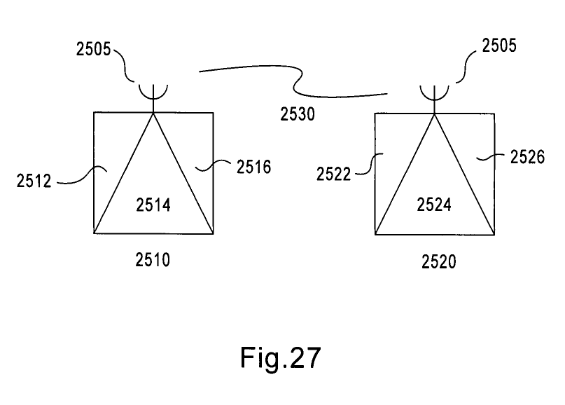

FIG. 27 illustrates a system according to an embodiment of the present invention. The system may include a terminal 2510, and an access point 2520, connected by a communication link 2530, which may be a radio link. If a radio link is used, the terminal 2510 and access point 2520 may include suitable communications hardware and software for communicating over the radio link including, but not limited to, respective antennas 2505.

The terminal 2510 may include a transmission unit 2512, which may be arranged to operate together with a processor 2514 to send frames of data to the access point 2520. Likewise, the terminal 2510 may include a reception unit 2516 configured to operate together with a processor 2514 to receive frames of data from the access point.

Similarly, the access point 2520 may include a transmission unit 2522, which may be arranged to operate together with a processor 2524 to send frames of data to the terminal 2510. Furthermore, the access point 2520 may include a reception unit 2526 configured to operate together with a processor 2524 to receive frames of data from the access point.

The terminal 2510 and the access point 2520 may be implemented in respective hardware, software, or combination thereof. For example, processor 2514 or processor 2524 may, for example, be a general purpose computer or an application specific integrated circuit. The terminal 2510 and the access point 2520 may be provided with respective memories (not shown), which may be local to the respective terminal 2510 and access point 2520, or which may be remote from one or both of them.

Thus, each of the terminal 2510 and the access point 2520 may be implemented as a computer program embodied on a computer readable medium encoding instructions to perform various operations of the methods described above.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A method, comprising:
receiving a trigger frame from a first station;
triggering a service period based on receiving the trigger frame; and
sending a termination bit to the first station, wherein the sending the termination bit to the first station is configured to result in an end of the service period.

2. The method of claim 1, further comprising:
configuring the trigger frame to be an aggregate frame.

3. The method of claim 2, wherein the triggering the service period is based on correctly receiving at least one frame of the aggregate frame.

4. The method of claim 3, wherein the triggering the service period is based on correctly receiving fewer than all frames of the aggregate frame.

5. The method of claim 1, further comprising:
configuring the trigger frame to inform a second station that the first station is in full power state and able to receive data from the second station.

6. The method of claim 1, further comprising:
configuring the trigger frame to be a media access control service data unit.

7. The method of claim 1, further comprising:
configuring the trigger frame to comprise at least one of an inquiry access code, a power save multi poll, or an aggregation information frame.

8. The method of claim 1, wherein the receiving the trigger frame comprises receiving at least one of an uplink data frame or a management frame from a first station that is in power save state.

9. The method of claim 1, further comprising:
identifying the trigger frame using at least one flag.

10. The method of claim 1, further comprising:
specifying two trigger flags in at least one of an uplink aggregation control frame, a block ack request frame, or a block ack frame.

11. The method of claim 1, further comprising:
receiving a frame including a non-delivery enabled access channel flag from the first station; and
triggering transmission of data on non-delivery enabled access channels during the service period based on the non-delivery enabled access channel flag.

12. The method of claim 1, further comprising:
receiving a frame including a delivery enabled access channel flag from the first station; and
triggering transmission of data on delivery enabled access channels during the service period based on the non-delivery enabled access channel flag.

13. The method of claim 1, further comprising:
receiving a frame including a trigger flag in an uplink frame from the first station; and
triggering transmission of all traffic based on the trigger flag.

14. The method of claim 4, further comprising:
indicating that fewer than all frames of the aggregate frame are correctly received in a ack frame.

15. The method of claim 14, further comprising:
configuring the ack frame to be a block ack frame.

16. The method of claim 1, further comprising:
configuring the termination bit to comprise at least one of an end of service period bit or a more data bit.

17. The method of claim 1, further comprising:
providing the termination bit from a second station in full power to the first station when the first station is in power save.

18. The method of claim 1, further comprising:
providing the termination bit in a quality of service null frame aggregated with a last transmitted block ack frame.

19. The method of claim 1, further comprising:
providing the termination bit in an aggregation control frame.

20. The method of claim 1, further comprising:
providing the termination bit in an aggregated media access control service data unit.

21. A method, comprising:
sending a trigger frame to a second station, wherein the trigger frame is configured to trigger a service period based upon reception thereof;
receiving a termination bit from the second station; and
ending the service period based on the termination bit.

22. The method of claim 21, further comprising:
configuring the trigger frame to be an aggregate frame.

23. The method of claim 21, further comprising:
configuring the trigger frame to inform the second station that first station is in full power state and able to receive data from the second station.

24. The method of claim 21, further comprising:
configuring the trigger frame to be a media access control service data unit.

25. The method of claim 21, further comprising:
providing at least one flag in connection with the trigger frame.

26. The method of claim 21, further comprising:
specifying two trigger flags in at least one of an uplink aggregation control frame, a block ack request frame, or a block ack frame.

27. The method of claim 21, further comprising:
providing a frame including a non-delivery enabled access channel flag to the second station, wherein the frame is configured to trigger transmission of data on non-delivery enabled access channels during the service period based on the non-delivery enabled access channel flag.

28. The method of claim 21, further comprising:
providing a frame including a delivery enabled access channel flag from the first station, wherein the frame is configured to trigger transmission of data on delivery enabled access channels during the service period based on the non-delivery enabled access channel flag.

29. The method of claim 21, further comprising:
providing a frame including a trigger flag in an uplink frame from the first station, wherein the frame is configured to trigger transmission of all traffic based on the trigger flag.

30. A first station, comprising:
a transmission unit configured to send a trigger frame to a second station, wherein the trigger frame is configured to trigger a service period based upon reception thereof;
a reception unit configured to receive a termination bit from the second station; and
a processor unit configured to end the service period based on the termination bit.

31. A first station, comprising:
transmission means for sending a trigger frame to a second station, wherein the trigger frame is configured to trigger a service period based upon reception thereof;
reception means for receiving a termination bit from the second station; and
processor means for ending the service period based on the termination bit.

32. A second station, comprising:
reception means for receiving a trigger frame from a first station;
processor means for triggering a service period based on receiving the trigger frame; and
transmission means for sending a termination bit to the first station, wherein the sending the termination bit to the first station is configured to result in an end of the service period.

33. A second station, comprising:
a reception unit configured to receive a trigger frame from a first station;
a processor unit configured to trigger a service period based on receiving the trigger frame; and
a transmission unit configured to send a termination bit to the first station, wherein the sending the termination bit to the first station is configured to result in an end of the service period.

34. A method, comprising:
transmitting an ACK frame from a first station;
terminating a service period for delayed block acknowledgement using the ACK frame;
when a block acknowledgement frame is received and indicates that all transmitted frames were received correctly, maintaining a current state instead of triggering a new service period; and
when the block acknowledgement frame is received and indicates that not all the transmitted frames were received correctly, triggering the new service period.
